(19) United States
(12) Patent Application Publication
(10) Pub. No.: US 2026/0049524 A1
(43) Pub. Date: Feb. 19, 2026

(54) CORDLESS WINDOW BLIND AND WINDING MECHANISM THEREOF

(71) Applicant: Ya-Yin LIN, Chiayi City (TW)

(72) Inventor: Ya-Yin LIN, Chiayi City (TW)

(21) Appl. No.: 18/804,398

(22) Filed: Aug. 14, 2024

(51) Int. Cl. E06B 9/322

(52) U.S. Cl. CPC E06B 9/322; E06B 2009/3222; E06B 2009/3225

(57) ABSTRACT

A winding mechanism is for a cordless window blind that includes two lift strings. The winding mechanism includes two rods, two rotating wheels, and a resistance module. The rotating wheels are respectively and rotatably sleeved on the rods. Each of the rotating wheels includes a bottom wheel portion and a toothed ring portion. The toothed ring portions of the rotating wheels mesh with each other. The bottom wheel portion of one of the rotating wheels is rotatable to wind or unwind one of the lift strings. The resistance module is sleeved on one of the rods, and includes a rotating base frame that is rotatably sleeved on the one of the rods, and three external gears each of which is rotatable about an axis. The external gears mesh with the respective one of the rotating wheels that is rotatably sleeved on the one of the rods.

### FIELD

This disclosure relates to a window blind, and more particularly to a cordless window blind and a winding mechanism thereof.

### BACKGROUND

A cordless window blind generally includes a top rod, a blind unit that is disposed below the top rod and that is constituted by a plurality of slats which are arranged in an up-down direction, a counterweight member that is located under the blind unit, a string unit that extends in the up-down direction, that is connected to the slats and the counterweight member, and that extends to the top rod, and a winding module that is disposed on the top rod and that is connected to the string unit. The winding module generally includes a first rotating wheel that winds the string unit, a second rotating wheel that urges the first rotating wheel to rotate, an idler-wheel, and a winding resilient strip that has two end portions respectively wound around the second rotating wheel and the idler-wheel. The winding resilient strip has a winding resilient force that drives the second rotating wheel to rotate the first rotating wheel to wind the string unit. A weight of the counterweight member matches the winding resilient force, thus the blind unit may stay in any position in which a user stops pushing up or pulling down the blind unit.

However, in order to precisely stop the blind unit in any position in which the user stops pushing or pulling the blind unit, the weight of the counterweight member has to be precisely designed according to a weight of the blind unit and the winding resilient force of the winding resilient strip, thereby lowering tolerance of the counterweight design of the counterweight member. The weight of the counterweight member may easily exceed the tolerance, and once the weight of the counterweight member exceeds the tolerance, the winding module may not be immediately stopped by the counterweight member after the user stops pushing up or pulling down the blind unit.

### SUMMARY

Therefore, an object of the disclosure is to provide a winding mechanism that can alleviate at least one of the drawbacks of the prior art.

According to the disclosure, the winding mechanism is for a cordless window blind. The cordless window blind includes a top rod and two lift strings. The winding mechanism is adapted to be mounted to the top rod and adapted for winding or unwinding one of the lift strings. The winding mechanism includes a housing, two rotating wheels, a resistance module, and a winding resilient strip. The housing is adapted to be fixedly connected to the top rod and includes two spaced-apart rods that are parallel to each other and that extend vertically. The rotating wheels are respectively and rotatably sleeved on the rods. Each of the rotating wheels includes a bottom wheel portion, a transmission wheel portion, and a toothed ring portion that are coaxially interconnected in an up-down direction. The toothed ring portions of the rotating wheels mesh with each other. The bottom wheel portion of one of the rotating wheels is connected to and rotatable to wind or unwind the one of the lift strings. The resistance module is sleeved on one of the rods, and includes a rotating base frame that is rotatably sleeved on the one of the rods, and three external gears each of which is rotatably disposed on the rotating base frame and is rotatable about an axis extending in the up-down direction. The external gears mesh with an inner periphery of the bottom wheel portion of the respective one of the rotating wheels that is rotatably sleeved on the one of the rods. The winding resilient strip has two end portions that are respectively connected to and able to be respectively and resiliently wound around the transmission wheel portions of the rotating wheels. The winding resilient strip urges the rotating wheels to rotate when the winding resilient strip is unwound from one of the transmission wheel portions and wound around another one of the transmission wheel portions. The winding resilient strip tends to wind around another one of the rotating wheels that is not connected to the one of the lift strings.

Another object of the disclosure is to provide a cordless window blind having two of the abovementioned winding mechanisms.

According to the disclosure, the cordless window blind includes a window blind mechanism and two of the winding mechanisms as mentioned above. The window blind mechanism includes a top rod that extends in a left-right direction, a blind unit that is disposed below the top rod, a counterweight member that is located at a bottom end of the blind unit, and two lift strings that are spaced apart from each other in the left-right direction, that extend in an up-down direction, that are connected to the counterweight member and the blind unit, and that extend into the top rod. The winding mechanisms are mounted to the top rod, are arranged in the left-right direction, and are respectively connected to the lift strings. A sum of winding resilient forces of the winding resilient strips of the winding mechanisms match a weight of the counterweight member.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a front view of a first embodiment of a cordless window blind according to the present disclosure.

FIG. 2 is a fragmentary, partly exploded perspective view of a structure of a winding mechanism of the first embodiment.

FIG. 3 is another fragmentary, partly exploded perspective view, illustrating the structure of the winding mechanism of the first embodiment with a top seat of the winding mechanism omitted.

FIG. 4 is a fragmentary sectional top view of the winding mechanism of the first embodiment.

FIG. 5 is a fragmentary sectional side view of the structure of the winding mechanism of the first embodiment.

FIG. 6 is a fragmentary front view of a second embodiment of the cordless window blind according to the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

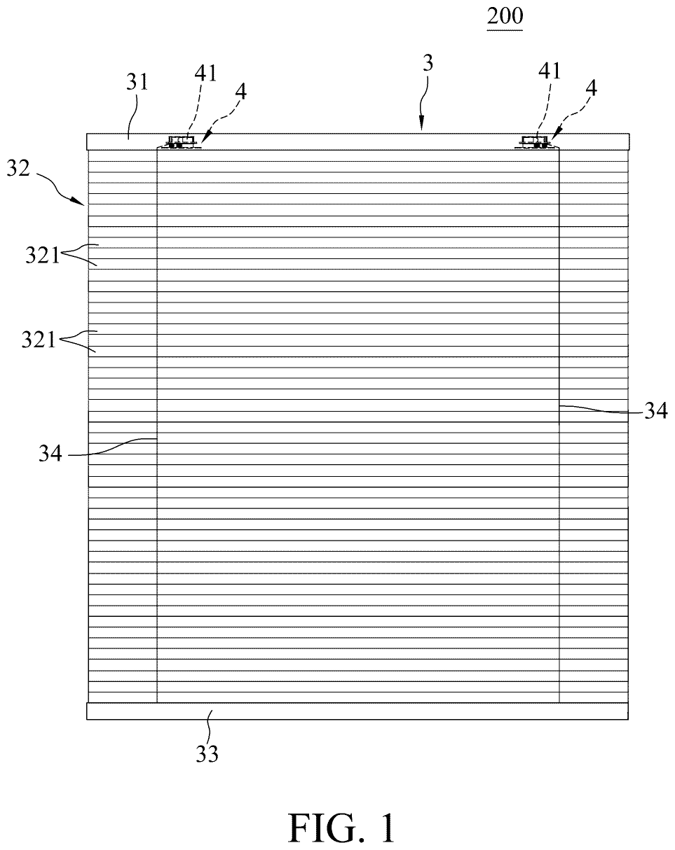

Referring to FIG. 1, a first embodiment of a cordless window blind 200 according to the present disclosure includes a window blind mechanism 3 that is fixed to a wall surface and that is retractable in an up-down direction, and two winding mechanisms 4 that are arranged in a left-right direction, and that are mounted to the window blind mechanism 3 for controlling retraction and extension of the window blind mechanism 3.

The window blind mechanism 3 is configured to be a Venetian blind, and includes a top rod 31 that is fixedly connected to the wall surface and that extends in the left-right direction, a blind unit 32 that is disposed below the top rod 31, a counterweight member 33 that extends in the left-right direction and that is disposed on and located at a bottom end of the blind unit 32, and two lift strings 34 that are spaced apart from each other in the left-right direction, that extend in the up-down direction, that are connected to the counterweight member 33 and the blind unit 32, and that extend upwardly from the counterweight member 33 into the top rod 31.

The blind unit 32 includes a plurality of blind slats 321 that extend in the left-right direction, and that are spaced apart from each other and arranged in the up-down direction below the top rod 31. Each of the lift strings 34 extends in the up-down direction and interconnects the blind slats 321 in the up-down direction. The lift strings 34 extend upwardly from the blind slats 321, respectively extend through left and right end portions of the top rod 31, and then extend toward each other in the left-right direction so as to be respectively connected to the winding mechanisms 4.

Because the window blind mechanism 3 is a conventional apparatus that has many types, and is not an important aspect of this disclosure, a detailed description thereof is omitted.

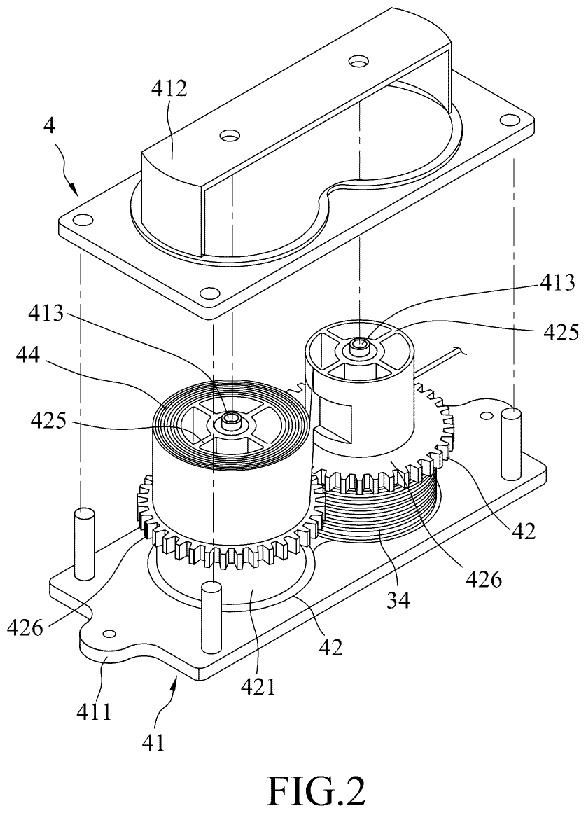

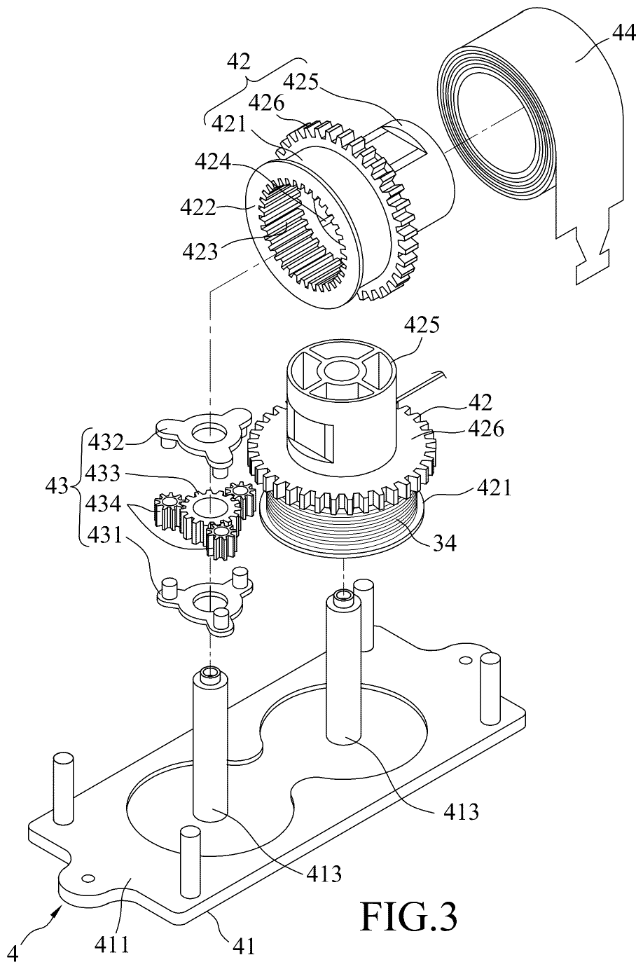

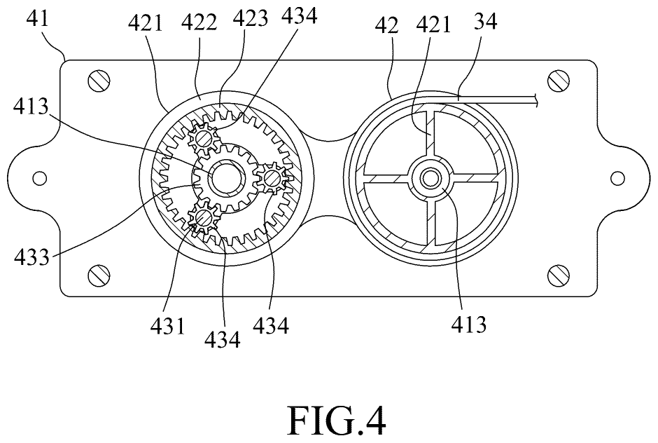

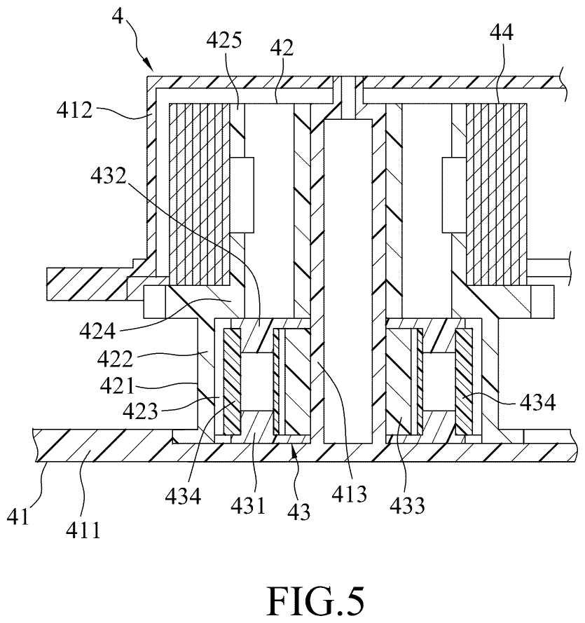

Referring to FIGS. 1, 2, 3, 4, and 5, because the winding mechanisms 4 have the same structures, for convenience of description, structure and operation of only one of the winding mechanisms 4 will be described below.

The winding mechanism 4 includes a housing 41 that is fixedly connected to the top rod 31, two rotating wheels 42 that are rotatably disposed on the housing 41, a resistance module 43 that is disposed between the housing 41 and one of the rotating wheels 42, and a winding resilient strip 44 that is disposed between the rotating wheels 42. One of the rotating wheels 42 is connected to the respective one of the lift strings 34.

The housing 41 includes a bottom seat 411 and a top seat 412 that are connected to each other in the up-down direction, and two spaced-apart rods 413 that extend upwardly from the bottom seat 411 into the top seat 412 (i.e., the rods 413 extend vertically) and that are parallel to each other.

The rotating wheels 42 are respectively and rotatably sleeved on the rods 413. Each of the rotating wheels 42 has a bottom wheel portion 421, a transmission wheel portion 425, and a toothed ring portion 426 that are coaxially interconnected in the up-down direction. For each of the rotating wheels 42, the toothed ring portion 426 is located between the bottom wheel portion 421 and the transmission wheel portion 425, and has a gear teeth structure that is formed on an outer periphery thereof. The toothed ring portions 426 of the rotating wheels 42 mesh with each other so that the rotating wheels 42 transmit rotation to each other.

The bottom wheel portion 421 of the one of the rotating wheels 42 is connected to the respective one of the lift strings 34, and is drivable to rotate to wind or unwind the respective one of the lift strings 34. The bottom wheel portion 421 of another one of the rotating wheels 42 covers the resistance module 43. The bottom wheel portion 421 of the another one of the rotating wheels 42 that covers the resistance module 43 has an annular meshing wall 422 that is sleeved on the resistance module 43, and a limiting top wall 424 that is disposed on a top side of the annular meshing wall 422 and that is located above the resistance module 43. An inner surface of the annular meshing wall 422 is provided with a gear teeth structure 423 that meshes with the resistance module 43. The limiting top wall 424 is used to limit axial movement of the resistance module 43 (i.e., movement of the resistance module 43 in the up-down direction). In one embodiment, the resistance module 43 may be covered by the bottom wheel portion 421 of the one of the rotating wheels 42 that is connected to the respective one of the lift strings 34, and the bottom wheel portion 421 of the one of the rotating wheels 42 has the annular meshing wall 422.

The resistance module 43 is sleeved on the respective one of the rods 413, and is located in the bottom wheel portion 421 of the another one of the rotating wheels 42. The resistance module 43 includes a rotating base frame 431 and a rotating top frame 432 that are rotatably sleeved on the respective one of the rods 413 and that are spaced apart from each other in the up-down direction (i.e., the rotating top frame 432 is located above the rotating base frame 431), three external gears 434 that are arranged about a periphery of the respective one of the rods 413 and each of which is rotatably disposed between the rotating base frame 431 and the rotating top frame 432, and a central gear 433 that is non-rotatably sleeved on the respective one of the rods 413 and that is disposed between the rotating base frame 431 and the rotating top frame 432. The central gear 433 meshes with the external gears 434. The external gears 434 is surrounded by and mesh with the gear teeth structure 423 of the annular meshing wall 422 of the another one of the rotating wheels 42 (i.e., the external gears 434 mesh with an inner periphery of the bottom wheel portion 421 of the another one of the rotating wheels 42). Each of the external gears 434 is rotatable about an axis that extends in the up-down direction. The rotating top frame 432 is axially limited by the limiting top wall 424 of the bottom wheel portion 421 of the another one of the rotating wheels 42 on the external gears 434.

The resistance module 43 provides static friction between the another one of the rotating wheels 42 and the respective one of the rods 413 through structural designs of the central gear 433 that is fixed to the respective one of the rods 413 and the external gears 434 that mesh between the central gear 433 and the bottom wheel portion 421 of the another one of the rotating wheels 42.

The winding resilient strip 44 has two end portions that are respectively and fixedly connected to the transmission wheel portions 425 of the rotating wheels 42, and that are able to be respectively and resiliently wound around the transmission wheel portions 425. Each of the end portions of the winding resilient strip 44 is operable to be resiliently wound around or unwound from the respective one of the transmission wheel portions 425. For each of the winding mechanisms 4, the winding resilient strip 44 tends to wind around the transmission wheel portion 425 of the another one of the rotating wheels 42 that is not connected to the respective one of the lift strings 34. A winding resiliently force provided by the winding resilient strip 44 is far greater than the static friction provided by the resistance module 43. A sum of the winding resilient forces of the winding resilient strips 44 of the winding mechanisms 4 matches a weight of the counterweight member 33.

Referring to FIGS. 1, 2, and 4, when the cordless window blind 200 is in use, the counterweight member 33 or any one of the blind slats 321 can be pushed upwardly or pulled downwardly to drive operation of the winding mechanisms 4 through the lift strings 34, thereby adjusting a length of the blind unit 32 in the up-down direction. Hereinafter, the operation of one of the winding mechanisms 4 and the respective one of the lift strings 34 connected thereto will be described as an example.

When the counterweight member 33 or any one of the blind slats 321 is pulled downwardly, the lift string 34 is pulled downwardly and drives the rotating wheels 42 of the winding mechanism 4 to synchronously rotate such that the one of the rotating wheels 42 which is wound with the lift string 34 synchronously unwinds the lift string 34 and winds the winding resilient strip 44. Thus, the winding resilient strip 44 is unwound from the another one of the rotating wheels 42.

When a user stops pulling the counterweight member 33 or the any one of the blind slats 321 downwardly, because the weight of the counterweight member 33 matches the sum of the winding resilient forces of the winding resilient strips 44, and because there is the static friction provided by the resistance module 43 between the another one of the rotating wheels 42 and the housing 41, the rotating wheels 42 of the winding mechanism 4 immediately stop rotating. Hence, the blind slats 321 stay in a position in which the user stops pulling the counterweight member 33 downwardly.

On the contrary, when the counterweight member 33 or any one of the blind slats 321 is pushed upwardly by an external force that counters the weight of the counterweight member 33, the winding resilient strip 44 of the winding mechanism 4 winds around the another one of the rotating wheels 42 that is not connected to the lift string 34 (i.e., the winding resilient strip 44 is unwound from one of the transmission wheel portions 425 and wound around another one of the transmission wheel portions 425) such that the winding resilient strip 44 synchronously urges the rotating wheels 42 to rotate. Thus, the one of the rotating wheels 42 that is connected to the lift string 34 simultaneously unwinds the winding resilient strip 44 and winds the lift string 34 to retract the lift string 34 upwardly.

When the user stops pushing the counterweight member 33 or the any one of the blind slats 321 upwardly, because the weight of the counterweight member 33 matches the sum of the winding resilient forces of the winding resilient strips 44, and because there is the static friction provided by the resistance module 43, the rotating wheels 42 of the winding mechanism 4 immediately stop rotating. Hence, the blind slats 321 stay in a position in which the user stops pushing the counterweight member 33 upwardly.

Therefore, through a structural design in which the resistance module 43 is disposed between the housing 41 and the another one of the rotating wheels 42, the static friction between the housing 41 and the resistance module 43 becomes resistance to rotation of the rotating wheels 42. Hence, even when a counterweight design of the counterweight member 33 has a slightly large deviation from the sum of the winding resilient forces of the winding resilient strips 44 of the winding mechanisms 4, the blind unit 32 may still stay in any position in which the user stops pushing or pulling the blind unit 32.

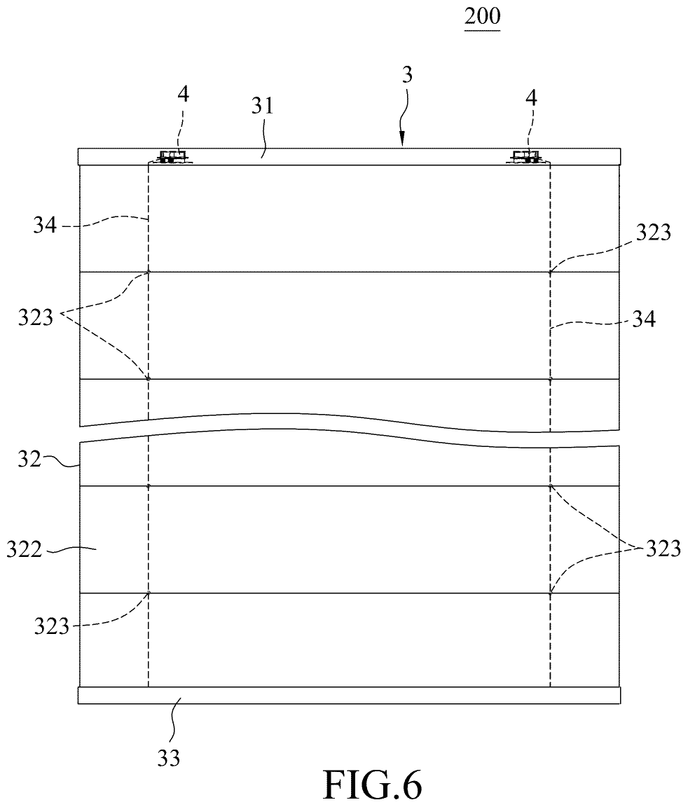

Referring to FIG. 6, a second embodiment of the cordless window blind 200 according to the present disclosure is different from the first embodiment in structural design of the blind unit 32. For the convenience of description, only the difference between the embodiments will be described.

In the second embodiment, the window blind mechanism 3 is configured to be a Roman shade, and the blind unit 32 includes a shade cloth 322 that extends in the up-down direction and that is resiliently deformable. The shade cloth 322 has a plurality of connecting portions 323 that are arranged in two lines which are spaced apart from each other in the left-right direction. The connecting portions 323 in each of the lines are spaced apart from each other in the up-down direction. Each of the lift strings 34 interconnects the connecting portions 323 in a respective one of the lines in the up-down direction. The lift strings 34 are used to pull the connecting portions 323 of the shade cloth 322 that are at different heights upwardly. When the lift strings 34 are wound upwardly by the winding mechanisms 4, the shade cloth 322 is retracted upwardly and stepwise. When the lift strings 34 are gradually unwound downwardly by the winding mechanisms 4, different sections of the shade cloth 322 that are at different heights are extended singly and downwardly in an up-down order.

Since the winding mechanisms 4 of the second embodiment operate in the same manner as those of the first embodiment, further description thereof is omitted.

It should be noted that, in the aforesaid two embodiments, it may not be necessary for the resistance module 43 to include the central gear 433. Static friction between the another one of the rotating wheels 42 and each of the external gears 434 may also be used to solve the problem of the slight deviation from the counterweight design so that the blind unit 32 may stay in any position in which the user stops pushing or pulling the blind unit 32.

In certain embodiments, the winding mechanisms 4 may be connected together, that is, the housings 41 of the winding mechanisms 4 may be connected together.

In summary, through the structural design of the housing 41, the rotating wheels 42, and the resistance module 43 of each of the winding mechanisms 4, in each of the winding mechanisms 4, the resistance module 43 applies the static friction between the housing 41 and the another one of the rotating wheels 42 to retard rotation of the rotating wheels 42 relative to the housing 41. Therefore, even when the counterweight design of the counterweight member 33 has a slightly large deviation, the blind unit 32 may still stay in any position in which the user stops pushing or pulling the blind unit 32. Hence, the problem that a conventional cordless window blind cannot stop immediately due to an improper counterweight design may be resolved. Therefore, the cordless window blind 200 of this disclosure may have a relatively larger tolerance of the counterweight design of the counterweight member 33, is indeed a relatively innovative, convenient, and practical innovation, and may indeed achieve the purpose of this disclosure.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A winding mechanism for a cordless window blind, the cordless window blind including a top rod and two lift strings, the winding mechanism being adapted to be mounted to the top rod and adapted for winding or unwinding one of the lift strings, the winding mechanism comprising:
a housing adapted to be fixedly connected to the top rod and including two spaced-apart rods that are parallel to each other and that extend vertically;
two rotating wheels respectively and rotatably sleeved on the rods, each of the rotating wheels including a bottom wheel portion, a transmission wheel portion, and a toothed ring portion that are coaxially interconnected in an up-down direction, the toothed ring portions of the rotating wheels meshing with each other, the bottom wheel portion of one of the rotating wheels being connected to and rotatable to wind or unwind the one of the lift strings;
a resistance module sleeved on one of the rods, and including a rotating base frame that is rotatably sleeved on the one of the rods, and three external gears each of which is rotatably disposed on the rotating base frame and is rotatable about an axis extending in the up-down direction, the external gears meshing with an inner periphery of the bottom wheel portion of the respective one of the rotating wheels that is rotatably sleeved on the one of the rods; and
a winding resilient strip having two end portions that are respectively connected to and able to be respectively and resiliently wound around the transmission wheel portions of the rotating wheels, the winding resilient strip urging the rotating wheels to rotate when the winding resilient strip is unwound from one of the transmission wheel portions and wound around another one of the transmission wheel portions, the winding resilient strip tending to wind around another one of the rotating wheels that is not connected to the one of the lift strings.

2. The winding mechanism as claimed in claim 1, wherein the resistance module further includes a central gear that is non-rotatably sleeved on the one of the rods and that meshes with the external gears.

3. The winding mechanism as claimed in claim 2, wherein the resistance module further includes a rotating top frame that is rotatably sleeved on the one of the rods and that is located above the rotating base frame, each of the external gears being rotatably disposed between the rotating base frame and the rotating top frame, the central gear being disposed between the rotating base frame and the rotating top frame.

4. The winding mechanism as claimed in claim 3, wherein the bottom wheel portion of the respective one of the rotating wheels that meshes with the external gears of the resistance module has an annular meshing wall that meshes with and surrounds the external gears, and a limiting top wall that is disposed on a top side of the annular meshing wall and that limits the rotating top frame on the external gears.

5. The winding mechanism as claimed in claim 1, wherein the resistance module further includes a rotating top frame that is rotatably sleeved on the one of the rods, and that is located above and spaced apart from the rotating base frame, each of the external gears being rotatably disposed between the rotating base frame and the rotating top frame.

6. The winding mechanism as claimed in claim 5, wherein the bottom wheel portion of the respective one of the rotating wheels that meshes with the external gears of the resistance module has an annular meshing wall that meshes with and surrounds the external gears, and a limiting top wall that is disposed on a top side of the annular meshing wall and that limits the rotating top frame on the external gears.

7. A cordless window blind comprising:
a window blind mechanism including a top rod that extends in a left-right direction, a blind unit that is disposed below the top rod, a counterweight member that is located at a bottom end of the blind unit, and two lift strings that are spaced apart from each other in the left-right direction, that extend in an up-down direction, that are connected to the counterweight member and the blind unit, and that extend into the top rod; and
two of the winding mechanisms of claim 1, the winding mechanisms being mounted to the top rod, being arranged in the left-right direction, and being respectively connected to the lift strings, a sum of winding resilient forces of the winding resilient strips of the winding mechanisms matching a weight of the counterweight member.

8. The cordless window blind as claimed in claim 7, wherein the blind unit includes a plurality of blind slats that extend in the left-right direction, and that are spaced apart from each other and arranged in the up-down direction below the top rod, each of the lift strings interconnecting the blind slats in the up-down direction.

9. The cordless window blind as claimed in claim 7, wherein the blind unit includes a shade cloth that extends in the up-down direction and that is resiliently deformable, the shade cloth having a plurality of connecting portions that are arranged in two lines which are spaced apart from each other in the left-right direction, the connecting portions in each of the lines being spaced apart from each other in the up-down direction, each of the lift strings interconnecting the connecting portions in a respective one of the lines in the up-down direction.
